(19) United States
(12) Patent Application Publication
(10) Pub. No.: US 2026/0349448 A1
(43) Pub. Date: Nov. 5, 2026

(54) Method and Apparatus for Determining Avoidance Way of Warehousing Robot and Electronic Device

(71) Applicant: Hangzhou Hikrobot Co., Ltd., Hangzhou, Zhejiang (CN)

(72) Inventors: Tao Liu, Hangzhou, Zhejiang (CN); Zhouwu Xu, Hangzhou, Zhejiang (CN)

(21) Appl. No.: 19/485,894

(22) PCT Filed: Feb. 17, 2025
(86) PCT No.: PCT/CN2025/077676

§ 371 Date: Nov. 19, 2025

(30) Foreign Application Priority Data
Dec. 3, 2024 (CN) 202411764423.0

(51) Int. Cl. G05D 1/693; G05D 101/00; G05D 107/70

(52) U.S. Cl. CPC G05D 1/693; G05D 2101/22; G05D 2107/70

(57) ABSTRACT

A method and apparatus for determining an avoidance way of a warehousing robot and an electronic device, comprising: determining whether there is a conflict area based on acquired height information and location information of the first warehousing robot in the first planned path and the second warehousing robot in the second planned path; acquiring time information when the first warehousing robot passes through the conflict area and time information when the second warehousing robot passes through the conflict area in response to determining that there is the conflict area; determining whether avoidance is required based on the time information corresponding to the first warehousing robot and the time information corresponding to the second warehousing robot, and determining a conflict type based on the location information in the first planned path and the second planned path in response to determining that the avoidance is required; determining an avoidance way based on robot types of two warehousing robots and the conflict type. The avoidance efficiency of the warehousing robot can be improved under the condition of the conflict area is accurately detected.

The present application claims the priority to a Chinese patent application No. 202411764423.0 filed with the China National Intellectual Property Administration (CNIPA) on Dec. 3, 2024, and entitled “METHOD AND APPARATUS FOR DETERMINING AVOIDANCE WAY OF WAREHOUSING ROBOT AND ELECTRONIC DEVICE”, which is incorporated herein by reference in its entirety.

### TECHNICAL FIELD

The present application relates to the technical field of warehousing and logistics, in particular to a method and an apparatus for determining an avoidance way of a warehousing robot and an electronic device.

### BACKGROUND

In a warehouse environment, using a warehousing robot to transfer goods is an efficient logistics solution. However, in case that multiple warehousing robots work at the same time, it is necessary for the warehousing robot to have an ability to avoid obstacles, to ensure they can move safely in a complex warehouse environment. At present, a general method is to identify whether different warehousing robots pass through the same path point within a preset time interval, determine a congestion area based on the same path point that different warehousing robots pass through, and then select a path that does not pass through the congestion area or a path that passes through few congestion areas as possible from the multiple paths planned by the warehousing robots. However, this solution merely considers a conflict in the same plane. In fact, a robot passing through a congestion area may not collide with other robots passing through the congestion area, and this solution has a situation that the path cannot bypass the congestion area.

### SUMMARY

The purpose of the embodiments of the present application is to provide a method and an apparatus for determining an avoidance way of a warehousing robot and an electronic device, so as to improve avoidance efficiency of the warehousing robot under the condition of a conflict area is accurately detected. The specific technical solutions are as follows:

In a first aspect, an embodiment of the present application provides a method for determining an avoidance way of a warehousing robot, including:
acquiring height information and location information of a first warehousing robot in a first planned path and a second warehousing robot in a second planned path;
determining whether there is a conflict area based on the height information and the location information in the first planned path and the second planned path;
acquiring, in response to determining that there is the conflict area, time information when the first warehousing robot passes through the conflict area and time information when the second warehousing robot passes through the conflict area;
determining whether avoidance is required based on the time information corresponding to the first warehousing robot and the time information corresponding to the second warehousing robot;
determining, in response to determining that the avoidance is required, a conflict type based on the location information in the first planned path and the second planned path;
determining an avoidance way based on robot types of two warehousing robots and the conflict type.

In one possible implementation, determining whether there is the conflict area based on the height information and location information in the first planned path and the second planned path includes:
determining, in response to determining that height information in the first planned path overlaps with height information in the second planned path, whether location information in the first planned path intersects with location information in the second planned path;
determining, in response to determining that the location information in the first planned path and the location information in the second planned path, the conflict area containing the location information in the first planned path and the location information in the second planned path.

In one possible implementation, determining whether the avoidance is required based on the time information corresponding to the first warehousing robot and the time information corresponding to the second warehousing robot includes: determining, in response to determining that a time interval during which the first warehousing robot enters and exits the conflict area overlaps with a time interval during which the second warehousing robot enters and exits the conflict area, that the avoidance is required.

In one possible implementation, determining, in response to determining that the avoidance is required, the conflict type based on the location information in the first planned path and the second planned path, including:
determining a first path vector \vec{a} of the first warehousing robot in the conflict area and a second path vector \vec{b} of the second warehousing robot in the conflict area based on the location information in the first planned path and the location information in the second planned path in the conflict area;
in response to determining that an included angle formed by the first path vector \vec{a} and the second path vector \vec{b} is an obtuse angle, determining that the conflict type is an opposite-direction conflict;
in response to determining that the included angle formed by the first path vector \vec{a} and the second path vector \vec{a} is not an obtuse angle, determining that the conflict type is a same-direction conflict.

In one possible implementation, the conflict type includes an opposite-direction conflict and a same-direction conflict;
determining the avoidance way based on the robot types of the two warehousing robots and the conflict type includes:
determining, in response to determining that the two warehousing robots are both ordinary warehousing robots and the conflict type is the same-direction conflict, a sequence in which the two warehousing robots enter the conflict area, a warehousing robot that enters the conflict area first travels normally, and a warehousing robot that enters the conflict area later waits, wherein the ordinary warehousing robot is a warehousing robot that maintains a constant height during travel.

In one possible implementation, the conflict type includes an opposite-direction conflict and a same-direction conflict;
determining the avoidance way based on the robot types of the two warehousing robots and the conflict type includes:
determining, in response to determining that the two warehousing robots are both ordinary warehousing robots and the conflict type is the opposite-direction conflict and neither of the two warehousing robots is located in the conflict area, a sequence in which the two warehousing robots enter the conflict area, a warehousing robot that enters the conflict area first travels normally, and a warehousing robot that enters the conflict area later waits, wherein the ordinary warehousing robot is a warehousing robot that maintains a constant height during travel;
searching, in response to determining that the two warehousing robots are both ordinary warehousing robots and the conflict type is the opposite-direction conflict and there is a warehousing robot located in the conflict area, for a first alternative path by a warehousing robot located in the conflict area for avoiding the conflict area; and the warehousing robot located in the conflict area travels following the first alternative path.

In one possible implementation, the conflict type includes an opposite-direction conflict and a same-direction conflict;
determining the avoidance way based on the robot types of the two warehousing robots and the conflict type includes:
determining, in response to determining that there is a sky transfer unit in the two warehousing robots and the conflict type is the same-direction conflict, a sequence in which the two warehousing robots enter the conflict area, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail.

In one possible implementation, the conflict type includes an opposite-direction conflict and a same-direction conflict;
determining the avoidance way based on the robot types of the two warehousing robots and the conflict type includes:
determining, in response to determining that there is a sky transfer unit in the two warehousing robots and the conflict type is the opposite-direction conflict and neither of the two warehousing robots is located in the conflict area, a sequence in which the two warehousing robots enter the conflict area, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail;
adjusting, in response to determining that there is the sky transfer unit in the two warehousing robots and the conflict type is the opposite-direction conflict and there is a warehousing robot located in the conflict area, a positioning-based height of the sky transfer unit by itself to avoid a non sky transfer unit.

In one possible implementation, adjusting the positioning-based height of the sky transfer unit by itself to avoid the non sky transfer unit, including:
determining, by the sky transfer unit, updated height information based on height information of the non sky transfer unit and a preset height value;
raising, by the sky transfer unit, the positioning-based height of the sky transfer unit based on the updated height information to avoid the non sky transfer unit;
the method further includes:
searching, in response to determining that the updated height information is greater than a maximum positioning-based height of the sky transfer unit, for an alternative planned path by the non sky transfer unit for avoiding the conflict area;
the non sky transfer unit traveling following the alternative planned path.

In a second aspect, an embodiment of the present application provides an apparatus for determining an avoidance way of a warehousing robot, including:
an acquisition module, configured to acquire height information and location information of a first warehousing robot in a first planned path and a second warehousing robot in a second planned path;
a conflict area determination module, configured to determine whether there is a conflict area based on the height information and the location information in the first planned path and the second planned path;
a time information acquisition module, configured to acquire, in response to determining that there is the conflict area, time information when the first warehousing robot passes through the conflict area and time information when the second warehousing robot passes through the conflict area;
an avoidance module, configured to determine whether avoidance is required based on the time information corresponding to the first warehousing robot and the time information corresponding to the second warehousing robot;
a conflict type determination module, configured to determine, in response to determining that the avoidance is required, a conflict type based on the location information in the first planned path and the second planned path;
an avoidance way determination module, configured to determine the avoidance way based on robot types of two warehousing robots and the conflict type.

In a third aspect, an embodiment of the present application provides an electronic device, including:
a memory, configured to store a computer program;
a processor, configured to implement any one of methods for determining an avoidance way of a warehousing robot mentioned above when executing the program stored on the memory.

An embodiment of the present application further provides a computer program product containing instructions, which when running on a computer, cause the computer to carry out any one of the method for determining an avoidance way of a warehousing robot mentioned above.

In the method for determining an avoidance way of a warehousing robot provided by the embodiment of the present application, including: acquiring the height information and the location information of the first warehousing robot in the first planned path and the second warehousing robot in the second planned path, determining whether there is a conflict area based on the height information and the location information in the first planned path and the second planned path; acquiring the time information when the first warehousing robot passes through the conflict area and the time information when the second warehousing robot passes through the conflict area in response to determining that there is the conflict area; determining whether the avoidance is required based on the time information corresponding to the first warehousing robot and the time information corresponding to the second warehousing robot, determining a conflict type based on the location information in the first planned path and the second planned path in response to determining that the avoidance is required; determining an avoidance way based on robot types of two warehousing robots and the conflict type. The avoidance efficiency of the warehousing robot can be improved under the condition of the conflict area is accurately detected.

Of course, it is not necessary for any product or method implementing the present application to achieve all the advantages described above simultaneously.

### BRIEF DESCRIPTION OF THE DRAWINGS

The accompanying drawings described herein are used to provide a further understanding of the present application and constitute a part of the present application. The illustrative embodiments of the present application and their descriptions are used to explain the present application and do not constitute an improper limitation on the present application.

In order to more clearly describe the technical solution of the embodiments of the present application or the prior art, accompanying drawings that need to be used in the embodiments or the prior art will be briefly introduced below. Obviously, the accompanying drawings described below are only some of the embodiments of the present application. For those skilled in the art, they may also obtain other embodiments based on these accompanying drawings.

FIG. 1 is a flow chart of a method for determining an avoidance way of a warehousing robot provided by an embodiment of the present application;

FIG. 2 is a schematic diagram of a sky transfer unit;

FIG. 3 is a schematic diagram of a conflict area;

FIG. 4 is a schematic diagram of a structure of an apparatus for determining an avoidance way of a warehousing robot provided by an embodiment of the present application;

FIG. 5 is a schematic diagram of a structure of an electronic device provided by an embodiment of the present application.

### DETAILED DESCRIPTION

Technical solutions in embodiments of the present application will be described clearly and completely below with reference to the accompanying drawings in the embodiments of the present application. Obviously, the described embodiments are only some, and not all, of the embodiments of the present application. All other embodiments obtained based on the embodiments in the present application by those skilled in the art fall into the scope of protection of the present application.

In a warehouse environment, using a warehousing robot to transfer goods is an efficient logistics solution. However, in case that multiple warehousing robots work at the same time, it is necessary for the warehousing robot to have an ability to avoid obstacles, to ensure they can move safely in a complex warehouse environment. At present, a general method is to identify whether different warehousing robots pass through the same path point at preset time, determine a congestion area based on the same path point that different warehousing robots pass through, and then select a path that does not pass through the congestion area or a path that passes through few congestion areas as possible from the multiple paths planned by the warehousing robots. However, this solution merely considers a conflict in the same plane. In fact, a robot passing through a congestion area may not collide with other robots passing through the congestion area, and this solution has a situation that the congestion path cannot be bypassed.

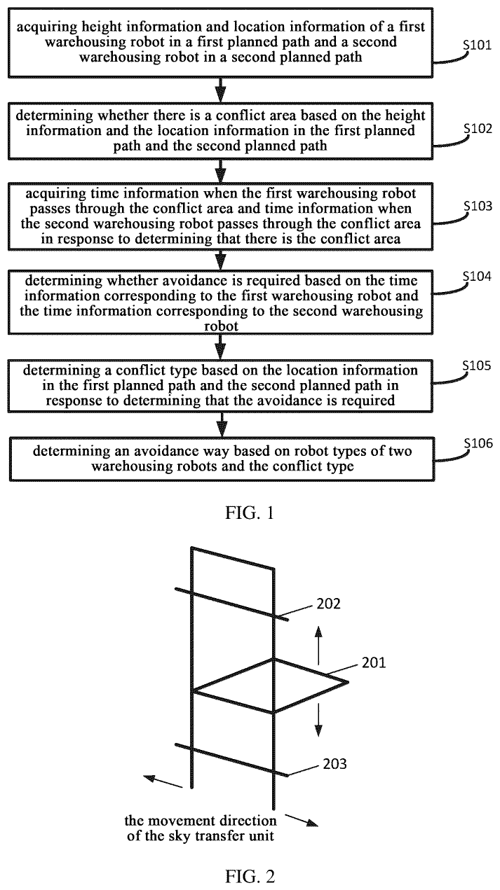

Therefore, a first aspect of the present application provides a method for determining an avoidance way of a warehousing robot, referring to FIG. 1, the method includes:

S101, acquiring height information and location information of a first warehousing robot in a first planned path and a second warehousing robot in a second planned path.

An overlapping space formed by the first planned path and the second planned path in space is referred to as a conflict area. It can be understood that only when there are at least two warehousing robots in the warehouse environment, can these warehousing robots collide with each other, and in this case, it is necessary to take measures to avoid. The conflict area is generally an overlapping space formed by the planned paths of two warehousing robots. Assuming there are three warehousing robots A, B and C which have planned paths respectively, a detection of a conflict area is that an overlapping between the planned path of A and the planned path of B is detected, then an overlapping between the planned path of A and the planned path of C is detected, and finally an overlapping between the planned path of B and the planned path of C is detected.

The planned path not only includes a path of the warehousing robot in a horizontal plane, but also includes height information of the warehousing robot during travel. This height information generally refers to height of goods that the warehousing robot carries, which includes height information of the warehousing robot itself and height information of the goods.

S102, determining whether there is a conflict area based on the height information and the location information in the first planned path and the second planned path.

Wherein, the location information generally refers to a position through which the warehousing robot moves in the horizontal plane, and the location information reflects a path of the warehousing robot in the horizontal plane.

S103, acquiring time information when the first warehousing robot passes through the conflict area and time information when the second warehousing robot passes through the conflict area in response to determining that there is the conflict area.

In response to determining that two warehousing robots may collide, it is not enough to only due to the presence of a conflict area. For example, there are two warehousing robots with identical planned paths, but one works in the daytime and the other works at night. In this case, the two warehousing robots will not collide each other at all, thus avoidance is not required. In the embodiment of the present application, it is not only necessary to determine whether there is a conflict area, but also to determine whether avoidance is required. To this end, it is necessary to acquire the time information corresponding to the warehousing robots within the conflict area, and determine whether there is a collision between the two warehousing robots based on the time information corresponding to the first warehousing robot within the conflict area and the time information corresponding to the second warehousing robot within the conflict area.

On one hand, the time information corresponding to the warehousing robot within the conflict area can be obtained by acquiring time information of the warehousing robot at each path point, that is, time when the warehousing robot enters the conflict area and time when the warehousing robot leaves the conflict area. On the other hand, time and travel speed of the warehousing robot when entering the conflict area can also be obtained. Since the planned path of the warehousing robot is known, time of the warehousing robot when leaving the conflict area can be estimated, and the time of the warehousing robot when entering the conflict area and leaving the conflict area can be obtained.

S104, determining whether avoidance is required based on the time information corresponding to the first warehousing robot and the time information corresponding to the second warehousing robot.

S105, determining a conflict type based on the location information in the first planned path and the second planned path in response to determining that the avoidance is required.

When the avoidance is required, that is, there must be a conflict between the two warehousing robots in space. In this case, it is necessary to further determine a conflict type based on the location information in the first planned path and the second planned path.

S106, determining an avoidance way based on robot types of two warehousing robots and the conflict type.

Robots include ordinary warehousing robots and Sky Transfer Units (STU) in types. The height of the ordinary warehousing robots is constant when it is running, which is a configured height. The configured height is related to a load of the ordinary warehousing robot. In a plan of a path of the ordinary warehousing robot, and when determining whether a position can be passed through, a height status of the ordinary warehousing robot is considered, wherein the height status is an overall height of the ordinary warehousing robot including the load. In response to determining that the overall height of the ordinary warehousing robot is greater than height at which the map is allowed to pass, the map area cannot be passed through, and otherwise, the map area can be passed through. The sky transfer unit can only move in a certain plane, specifically referring to FIG. 2, the sky transfer unit moves along a guide rail in a horizontal direction. A mechanism 201 for carrying goods moves up and down in a vertical direction.

In the method for determining an avoidance way of a warehousing robot provided by the embodiment of the present application, including: acquiring the height information and the location information of the first warehousing robot in the first planned path and the second warehousing robot in the second planned path, determining whether there is a conflict area based on the height information and the location information in the first planned path and the second planned path; acquiring the time information when the first warehousing robot passes through the conflict area and the time information when the second warehousing robot passes through the conflict area in response to determining that there is the conflict area; determining whether the avoidance is required based on the time information corresponding to the first warehousing robot and the time information corresponding to the second warehousing robot, determining a conflict type based on the location information in the first planned path and the second planned path in response to determining that the avoidance is required; determining an avoidance way based on robot types of two warehousing robots and the conflict type. The avoidance efficiency of the warehousing robot can be improved under the condition of the conflict area is accurately detected.

In one example, the above step S102 can specifically include:

Step 1, in response to determining that height information in the first planned path overlaps with height information in the second planned path overlap, determining whether location information in the first planned path intersects with location information in the second planned path.

In response to determining that the height information in the first planned path overlaps with the height information in the second planned path, it means that heights of goods carried by the two warehousing robots are almost the same, and it is easy for such two warehousing robots to collide with each other, so it is necessary to further determine whether the two warehousing robots intersect with each other in the horizontal plane. Specifically, determining whether the two warehousing robots intersect with each other in the horizontal plane can be achieved by observing whether the location information in the first planned path intersects with the location information in the second planned path.

In response to determining that the height information in the first planned path does not overlap with the height information in the second planned path, it is determined that the two warehousing robots do not overlap with each other in space and no subsequent processing is performed.

Step 2, in response to determining that the location information in the first planned path intersects with the location information in the second planned path intersect, determining the conflict area containing the location information in the first planned path and the location information in the second planned path.

The conflict area is an area obtained by taking an intersection of the location information in the first planned path and the location information in the second planned path.

In one example, the above step S104 can specifically include:

in response to determining that a time interval during which the first warehousing robot enters and exits the conflict area overlaps with a time interval during which the second warehousing robot enters and exits the conflict area, determining that the avoidance is required.

In response to determining that the time intervals during which the two warehousing robots enter and exit the conflict area overlaps, it indicates that the two warehousing robots have a high probability to collide with each other, at this time, it is necessary to take measures to avoid.

In one example, the above step S105 can specifically include:

Step A, determining a first path vector \vec{a} of the first warehousing robot in the conflict area and a second path vector \vec{b} of the second warehousing robot in the conflict area based on the location information in the first planned path and the location information in the second planned path in the conflict area.

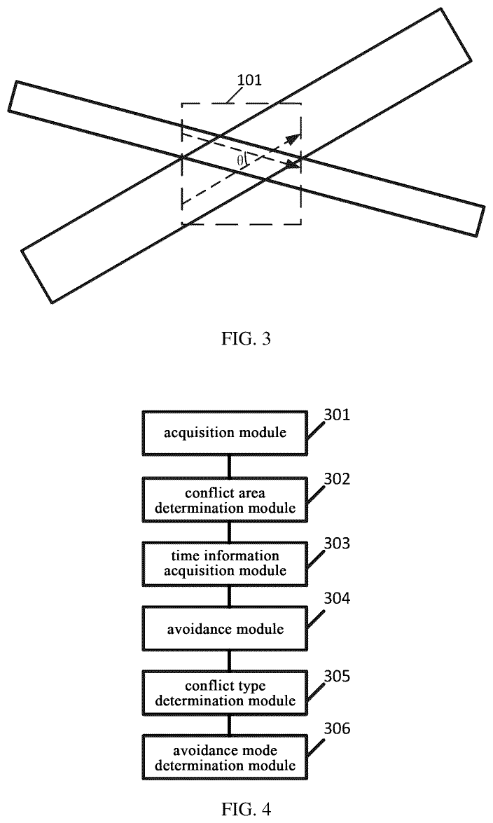

Referring to FIG. 3, in the conflict area 101, an included angle formed by the first path vector \vec{a} and the second path vector \vec{b} is 0, and the range of the included angle θ is: 0°≤θ≤180° can be observed.

Step B, determining the conflict type based on the included angle formed by the first path vector \vec{a} and the second path vector \vec{b}, wherein, in response to determining that the included angle formed by the first path vector \vec{a} and the second path vector \vec{b} is an obtuse angle, determining that the conflict type is an opposite-direction conflict;
in response to determining that the included angle formed by the first path vector \vec{a} and the second path vector \vec{b} is not an obtuse angle, determining that the conflict type is a same-direction conflict.

The included angle formed by the first path vector \vec{a} and the second path vector \vec{b} is 0;

$$cos ( θ ) = \frac{\vec{a} \cdot \vec{b}}{\vert \vec{a} \vert \times \vert \vec{b} \vert}$$

when cos (θ)≥0, the conflict type is the same-direction conflict;
when cos (θ)<0, the conflict type is the opposite-direction conflict.

In one example, the above step S106 can specifically include:
determining a sequence in which the two warehousing robots enter the conflict area in response to determining that the two warehousing robots are both ordinary warehousing robots and the conflict type is the same-direction conflict, a warehousing robot that enters the conflict area first travels normally, and a warehousing robot that enters the conflict area later waits, wherein the ordinary warehousing robot is a warehousing robot that maintains a constant height during travel.

In response to determining that the two warehousing robots are both ordinary warehousing robots, and the conflict type is the same-direction conflict, after determining the sequence in which the two warehousing robots enter the conflict area, a strategy of “first arrive, first pass” is adopted, wherein the warehousing robot that enters the conflict area first can travel normally following the planned path, and the warehousing robot that enters the conflict area later needs to wait for preset duration before entering the conflict area. The preset duration can be set based on the duration that the warehousing robot which first enters the conflict area passes through the conflict area, with the purpose of avoiding a collision between the warehousing robot entering the conflict area later and the warehousing robot entering the conflict area first in the conflict area.

In one example, the above step S106 can specifically include:
determining a sequence in which the two warehousing robots enter the conflict area in response to determining that the two warehousing robots are both ordinary warehousing robots and the conflict type is the opposite-direction conflict and neither of the two warehousing robots is located in the conflict area, a warehousing robot that enters the conflict area first travels normally, and a warehousing robot that enters the conflict area later waits, wherein the ordinary warehousing robot is a warehousing robot that maintains a constant height during travel;
searching for a first alternative path by a warehousing robot located in the conflict area for avoiding the conflict area, in response to determining that the two warehousing robots are both ordinary warehousing robots and the conflict type is the opposite-direction conflict and there is a warehousing robot located in the conflict area; and the warehousing robot located in the conflict area travels following the first alternative path.

In response to determining that the two warehousing robots are both ordinary warehousing robots, and the conflict type is the opposite-direction conflict, and neither of the two warehousing robots is located in the conflict area, the strategy of “first arrive, first pass” is still adopted.

In response to determining that the two warehousing robots are both ordinary warehousing robots and the conflict type is the opposite-direction conflict and there is a warehousing robot located in the conflict area, the warehousing robot located in the conflict area performs avoidance. The warehousing robot located in the conflict area can be the first warehousing robot or the second warehousing robot. The warehousing robot located in the conflict area searches for the first alternative path for avoiding the conflict area; and then travels following the first alternative path. In response to determining that the warehousing robot located in the conflict area fails to find an alternative path for avoiding the conflict area, it gives up the current planned path, and then can choose to stop moving.

When the two warehousing robots are both ordinary warehousing robots, the conflict type is the opposite-direction conflict, and the first warehousing robot and the second warehousing robot are both located in the conflict area, a warehousing robot with low priority actively performs avoidance, it searches for an alternative path for avoiding the conflict area; and then travels following the alternative path, a warehousing robot with high priority can continue travelling following the original planned path. In response to determining that both the two warehousing robots have the same priority, any of the warehousing robots can be chosen to actively perform avoidance since up to one warehousing robot at a time performs avoidance. In response to determining that the warehousing robots cannot perform avoidance, an alarm will be given.

In one example, the above step S106 can specifically include:
determining a sequence in which the two warehousing robots enter the conflict area in response to determining that there is a sky transfer unit in the two warehousing robots and the conflict type is the same-direction conflict, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail.

In response to determining that there is a sky transfer unit in the two warehousing robots, and the conflict type is the same-direction conflict, the strategy of “first arrive, first pass” is still adopted.

In one example, the above step S106 can specifically include:
determining a sequence in which the two warehousing robots enter the conflict area in response to determining that there is a sky transfer unit in the two warehousing robots the conflict type is the opposite-direction conflict and neither of the two warehousing robots is located in the conflict area, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail;
adjusting a positioning-based height of the sky transfer unit by itself to avoid a non sky transfer unit in response to determining that there is the sky transfer unit in the two warehousing robots and the conflict type is the opposite-direction conflict and there is a warehousing robot located in the conflict area.

In response to determining that there is the sky transfer unit in the two warehousing robots and the conflict type is the opposite-direction conflict and neither of the two warehousing robots is located in the conflict area, the strategy of “first arrive, first pass” is still adopted.

In response to determining that there is the sky transfer unit in the two warehousing robots and the conflict type is the opposite-direction conflict and there is a warehousing robot located in the conflict area, the warehousing robot located in the conflict area can be the sky transfer unit or a non sky transfer unit; the sky transfer unit determines updated height information based on height information of the non sky transfer unit and a preset height value; the sky transfer unit raises the positioning-based height of the sky transfer unit itself based on the updated height information to avoid a non sky transfer unit.

The preset height value is a fixed empirical value, which can be such as 50 mm. The updated height information determined by the sky transfer unit based on the height information of the non sky transfer unit and the preset height value is a height value greater than a sum of the height information of the non sky transfer unit and the preset height value.

In one example, the method further includes:
in response to determining that the updated height information is greater than a maximum positioning-based height of the sky transfer unit, the non sky transfer unit searches for an alternative planned path for avoiding the conflict area;
the non sky transfer unit traveling following the alternative planned path.

In response to determining that minimum updated height information determined by the sky transfer unit is greater than a maximum limit 202 of the sky transfer unit (203 in the Figure indicates a minimum limit of the sky transfer unit), selecting the alternative path of the non sky transfer unit for avoiding the conflict area. In response to determining that the non sky transfer unit cannot perform avoidance, the non sky transfer unit gives up the current planned path and can choose to stop moving.

In the embodiment of the present application, there will be no conflict between the sky transfer units. Since space interference between the sky transfer units will be completely avoided in the layout, it is not necessary to consider the space conflict between the two sky transfer units.

In the second aspect, an embodiment of the present application further provides an apparatus for determining an avoidance way of a warehousing robot, referring to FIG. 4, and the apparatus includes:
an acquisition module 301, configured to acquire height information and location information of a first warehousing robot in a first planned path and a second warehousing robot in a second planned path;
a conflict area determination module 302, configured to determine whether there is a conflict area based on the height information and the location information in the first planned path and the second planned path;
a time information acquisition module 303, configured to acquire time information when the first warehousing robot passes through the conflict area and time information when the second warehousing robot passes through the conflict area in response to determining that there is the conflict area;
an avoidance module 304, configured to determine whether avoidance is required based on the time information corresponding to the first warehousing robot and the time information corresponding to the second warehousing robot;
a conflict type determination module 305, configured to determine a conflict type based on the location information in the first planned path and the second planned path in response to determining that the avoidance is required;
an avoidance way determination module 306, configured to determine the avoidance way based on robot types of two warehousing robots and the conflict type.

In one possible implementation, the conflict area determination module is specifically configured to: determine whether the location information in the first planned path intersects with the location information in the second planned path, in response to determining that the height information in the first planned path overlaps with the height information in the second planned path; determine the conflict area containing the location information in the first planned path and the location information in the second planned path, in response to determining that the location information in the first planned path intersects with the location information in the second planned path.

In one possible implementation, the avoidance module is specifically configured to determine that the avoidance is required in response to determining that a time interval during which the first warehousing robot enters and exits the conflict area overlaps with a time interval during which the second warehousing robot enters and exits the conflict area.

In one possible implementation, the conflict type determination module is specifically configured to:
determine a first path vector \vec{a} of the first warehousing robot in the conflict area and a second path vector \vec{b} of the second warehousing robot in the conflict area based on the location information in the first planned path and the location information in the second planned path in the conflict area;
determine the conflict type based on an included angle formed by the first path vector \vec{a} and the second path vector \vec{b}, wherein, in response to determining that the included angle formed by the first path vector \vec{a} and the second path vector \vec{b} is an obtuse angle, the conflict type is determined to be an opposite-direction conflict;
in response to determining that the included angle formed by the first path vector \vec{a} and the second path vector \vec{b} is not an obtuse angle, the conflict type is determined to be a same-direction conflict.

In one possible implementation, the conflict type includes an opposite-direction conflict and a same-direction conflict;
the avoidance way determination module is specifically configured to determine a sequence in which the two warehousing robots enter the conflict area in response to determining that the two warehousing robots are both ordinary warehousing robots and the conflict type is the same-direction conflict, a warehousing robot that enters the conflict area first travels normally, and a warehousing robot that enters the conflict area later waits, wherein the ordinary warehousing robot is a warehousing robot that maintains a constant height during travel.

In one possible implementation, the conflict type includes an opposite-direction conflict and a same-direction conflict;
the avoidance way determination module is specifically configured to:
determine a sequence in which the two warehousing robots enter the conflict area in response to determining that the two warehousing robots are both ordinary warehousing robots, the conflict type is the opposite-direction conflict and neither of the two warehousing robots is located in the conflict area, a warehousing robot that enters the conflict area first travels normally, and a warehousing robot that enters the conflict area later waits, wherein the ordinary warehousing robot is a warehousing robot that maintains a constant height during travel;
search for a first alternative path by a warehousing robot located in the conflict area for avoiding the conflict area, in response to determining that the two warehousing robots are both ordinary warehousing robots and the conflict type is the opposite-direction conflict and there is a warehousing robot located in the conflict area; and the warehousing robot located in the conflict area travels following the first alternative path.

In one possible implementation, the conflict type includes an opposite-direction conflict and a same-direction conflict;
the avoidance way determination module is specifically configured to determine a sequence in which the two warehousing robots enter the conflict area in response to determining that there is a sky transfer unit in the two warehousing robots and the conflict type is the same-direction conflict, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail.

In one possible implementation, the conflict type includes an opposite-direction conflict and a same-direction conflict;
the avoidance way determination module is specifically configured to:
determine a sequence in which the two warehousing robots enter the conflict area in response to determining that there is a sky transfer unit in the two warehousing robots and the conflict type is the opposite-direction conflict and neither of the two warehousing robots is located in the conflict area, a warehousing robot that enters the conflict area first travels normally, and a warehousing robot that enters the conflict area later waits, wherein the sky transfer unit is a warehousing robot with a variable positioning-based height in a vertical direction in during travel, and the sky transfer unit moves horizontally along a guide rail;
adjust a positioning-based height of the sky transfer unit by itself to avoid a non sky transfer unit, in response to determining that there is the sky transfer unit in the two warehousing robots and the conflict type is the opposite-direction conflict and there is a warehousing robot located in the conflict area.

In one possible implementation, adjusting the positioning-based height of the sky transfer unit by itself to avoid the non sky transfer unit includes:
determining, by the sky transfer unit, updated height information based on height information of the non sky transfer unit and a preset height value;
raising, by the sky transfer unit, the positioning-based height of the sky transfer unit based on the updated height information to avoid the non sky transfer unit;
the apparatus further includes:
a path searching module, configured to search for an alternative planned path by the non sky transfer unit for avoiding the conflict area, in response to determining that the updated height information is greater than a maximum positioning-based height of the sky transfer unit;
a control module, configured to control the non sky transfer unit to travel following the alternative planned path.

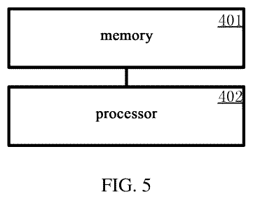

An embodiment of the present application further provides an electronic device, as shown in FIG. 5, including:
a memory 401, configured to store a computer program;
a processor 402, configured to implement any one of the methods for determining an avoidance way of a warehousing robot mentioned above when executing the computer program stored on the memory 401.

The electronic device mentioned above can further include a communication bus and/or a communication interface, and the processor 402, the communication interface, and the memory 401 communicate with each other via the communication bus.

The communication bus mentioned above in the electronic device can be a Peripheral Component Interconnect (PCI) bus or an Extended Industry Standard Architecture (EISA) bus, etc. The communication bus can be divided into an address bus, a data bus, a control bus and so on. For ease of presentation, only a thick line is shown in the figure, but this does not mean that there is only one bus or one type of bus.

The communication interface is used for communication between the above electronic device and other devices.

The Memory may include a random access memory (RAM) or a non-volatile memory (NVM), such as at least one disk memory. Optionally, the memory may also be at least one storage device located away from the aforementioned processor.

The above processor may be a general-purpose processor, including a central processing unit (CPU), a network processor (NP), etc.; it may also be a digital signal processor (DSP), an application specific integrated circuit (ASIC), a field-programmable gate array (FPGA) or other programmable logic devices, discrete gates or transistor logic devices, discrete hardware components.

In yet another embodiment provided by the present application, a computer-readable storage medium is further provided, which has a computer program stored therein, which when executed by a processor, carries out the steps of any one of the methods for determining an avoidance way of a warehousing robot mentioned above.

In yet another embodiment provided by the present application, a computer program product containing instructions is further provided, which when running on a computer, cause the computer to carry out any one of the methods for determining an avoidance way of a warehousing robot in the above embodiment.

In the above embodiments, it may be implemented in whole or in part by software, hardware, firmware or any combination thereof. When implemented in software, it can be implemented in whole or in part in the form of a computer program product. The computer program product includes one or more computer instructions. When the computer program instructions are loaded and executed on a computer, the processes or functions described in the embodiments of the present application are generated in whole or in part. The computer may be a general purpose computer, special purpose computer, computer network, or other programmable device. The computer instructions may be stored in a computer readable storage medium or transmitted from one computer readable storage medium to another computer readable storage medium, for example, the computer instructions may be transmitted from a website, computer, server or data center to another website, computer, server, or data center by wire (such as coaxial cable, fiber optic, digital subscriber line (DSL)) or wirelessly (such as infrared, wireless, microwave, etc.). The computer-readable storage medium may be any available medium that can be accessed by a computer or a data storage device such as a server and a data center and the like that includes an integration of one or more available medium. The available medium may be magnetic media (such as a floppy disk, a hard disk, a magnetic tape), optical media (such as DVD), or solid state disk (SSD) and the like.

It should be noted that in this article, relational terms such as first and second are only to distinguish one entity or operation from another, and do not necessarily require or imply any actual relationship or order between these entities or operations. Moreover, the terms “include”, “comprise”, or any other variation thereof are intended to encompass a non-exclusive inclusion, such that a process, method, article, or device that includes a series of elements not only includes those elements, but also other elements that are not explicitly listed, or also include elements inherent in such a process, method, article, or device. Without further limitations, the elements limited by the statement “including one . . . ” do not exclude the existence of other identical elements in the process, method, article, or device that includes the elements.

The various embodiments in this specification are described in a relevant manner, and the same and similar parts between the various embodiments can be referred to each other, and each embodiment focuses on the differences from other embodiments. In particular, for the embodiments of apparatus, since the embodiments are basically similar to the embodiments of the method, the description is relatively simple, and the relevant points can be referred to the partial description of the embodiment of the method.

The above descriptions are only preferred embodiments of the present application, and are not intended to limit the scope of protection of the present application. Any modifications, equivalent replacements, improvements, etc. made within the spirit and principles of the present application shall be included within the scope of protection of the present application.

1. A method for determining an avoidance way of a warehousing robot, comprising:
acquiring height information and location information of a first warehousing robot in a first planned path and a second warehousing robot in a second planned path;
determining whether there is a conflict area based on the height information and the location information in the first planned path and the second planned path;
acquiring, in response to determining that there is the conflict area, time information when the first warehousing robot passes through the conflict area and time information when the second warehousing robot passes through the conflict area;
determining whether avoidance is required based on the time information corresponding to the first warehousing robot and the time information corresponding to the second warehousing robot;
determining, in response to determining that the avoidance is required, a conflict type based on the location information in the first planned path and the second planned path;
determining an avoidance way based on robot types of two warehousing robots and the conflict type.

2. The method according to claim 1, wherein determining whether there is the conflict area based on the height information and the location information in the first planned path and the second planned path, comprising:
determining, in response to determining that height information in the first planned path overlaps with height information in the second planned path, whether location information in the first planned path intersects with location information in the second planned path;
determining, in response to determining that the location information in the first planned path intersects with the location information in the second planned path, the conflict area containing the location information in the first planned path and the location information in the second planned path.

3. The method according to claim 1, wherein determining whether the avoidance is required based on the time information corresponding to the first warehousing robot and the time information corresponding to the second warehousing robot, comprising:
determining, in response to determining that a time interval during which the first warehousing robot enters and exits the conflict area overlaps with a time interval during which the second warehousing robot enters and exits the conflict area, that the avoidance is required.

4. The method according to claim 1, wherein determining, in response to determining that the avoidance is required, the conflict type based on the location information in the first planned path and the second planned path, comprising:
determining a first path vector \vec{a} of the first warehousing robot in the conflict area and a second path vector \vec{b} of the second warehousing robot in the conflict area based on the location information in the first planned path and the location information in the second planned path in the conflict area;
in response to determining that an included angle formed by the first path vector \vec{a} and the second path vector \vec{b} is an obtuse angle, determining that the conflict type is an opposite-direction conflict;
in response to determining that the included angle formed by the first path vector \vec{a} and the second path vector \vec{a} is not an obtuse angle, determining that the conflict type is a same-direction conflict.

5. The method according to claim 1, wherein the conflict type comprises an opposite-direction conflict and a same-direction conflict;
determining the avoidance way based on the robot types of the two warehousing robots and the conflict type comprises:
determining, in response to determining that the two warehousing robots are both ordinary warehousing robots and the conflict type is the same-direction conflict, a sequence in which the two warehousing robots enter the conflict area, a warehousing robot that enters the conflict area first travels normally, and a warehousing robot that enters the conflict area later waits, wherein the ordinary warehousing robot is a warehousing robot that maintains a constant height during travel.

6. The method according to claim 1, wherein the conflict type comprises an opposite-direction conflict and a same-direction conflict;
determining the avoidance way based on the robot types of the two warehousing robots and the conflict type comprises:
determining, in response to determining that the two warehousing robots are both ordinary warehousing robots and the conflict type is the opposite-direction conflict and neither of the two warehousing robots is located in the conflict area, a sequence in which the two warehousing robots enter the conflict area, a warehousing robot that enters the conflict area first travels normally, and a warehousing robot that enters the conflict area later waits, wherein the ordinary warehousing robot is a warehousing robot that maintains a constant height during travel;
searching, in response to determining that the two warehousing robots are both ordinary warehousing robots and the conflict type is the opposite-direction conflict and there is a warehousing robot located in the conflict area, for a first alternative path by a warehousing robot located in the conflict area for avoiding the conflict area; and the warehousing robot located in the conflict area travels following the first alternative path.

7. The method according to claim 1, wherein the conflict type comprises an opposite-direction conflict and a same-direction conflict;
determining the avoidance way based on the robot types of the two warehousing robots and the conflict type comprises:
determining, in response to determining that there is a sky transfer unit in the two warehousing robots and the conflict type is the same-direction conflict, a sequence in which the two warehousing robots enter the conflict area, a warehousing robot that enters the conflict area first travels normally, and a warehousing robot that enters the conflict area later waits, wherein the sky transfer unit is a warehousing robot with a variable positioning-based height in a vertical direction during travel, and the sky transfer unit moves horizontally along a guide rail.

8. The method according to claim 1, wherein the conflict type comprises an opposite-direction conflict and a same-direction conflict;
determining the avoidance way based on the robot types of the two warehousing robots and the conflict type comprises:
determining, in response to determining that there is a sky transfer unit in the two warehousing robots and the conflict type is the opposite-direction conflict and neither of the two warehousing robots is located in the conflict area, a sequence in which the two warehousing robots enter the conflict area, a warehousing robot that enters the conflict area first travels normally, and a warehousing robot that enters the conflict area later waits, wherein the sky transfer unit is a warehousing robot with a variable positioning-based height in a vertical direction in during travel, and the sky transfer unit moves horizontally along a guide rail;
adjusting, in response to determining that there is the sky transfer unit in the two warehousing robots and the conflict type is the opposite-direction conflict and there is a warehousing robot located in the conflict area, a positioning-based height of the sky transfer unit by itself to avoid a non sky transfer unit.

9. The method according to claim 8, wherein adjusting the positioning-based height of the sky transfer unit by itself to avoid the non sky transfer unit, comprising:
determining, by the sky transfer unit, updated height information based on height information of the non sky transfer unit and a preset height value;
raising, by the sky transfer unit, the positioning-based height of the sky transfer unit based on the updated height information to avoid the non sky transfer unit;
the method further comprises:
searching, in response to determining that the updated height information is greater than a maximum positioning-based height of the sky transfer unit, for an alternative planned path by the non sky transfer unit for avoiding the conflict area;
the non sky transfer unit traveling following the alternative planned path.

10. An apparatus for determining an avoidance way of a warehousing robot, comprising:
an acquisition module, configured to acquire height information and location information of a first warehousing robot in a first planned path and a second warehousing robot in a second planned path;
a conflict area determination module, configured to determine whether there is a conflict area based on the height information and the location information in the first planned path and the second planned path;
a time information acquisition module, configured to acquire, in response to there is the conflict area, time information when the first warehousing robot passes through the conflict area and time information when the second warehousing robot passes through the conflict area;
an avoidance module, configured to determine whether avoidance is required based on the time information corresponding to the first warehousing robot and the time information corresponding to the second warehousing robot;
a conflict type determination module, configured to determine, in response to the avoidance is required, a conflict type based on the location information in the first planned path and the second planned path;
an avoidance way determination module, configured to determine an avoidance way based on robot types of two warehousing robots and the conflict type.

11. An electronic device, comprising:
a memory, configured to store a computer program;
a processor, configured to implement the method according to claim 1 when executing the computer program stored on the memory.
